(19) United States
(12) Patent Application Publication
(10) Pub. No.: US 2026/0219862 A1
(43) Pub. Date: Jul. 30, 2026

(54) SOFTWARE INSTALLATION METHOD FOR CLOUD PHONE, ELECTRONIC DEVICE AND STORAGE MEDIUM

(71) Applicant: Guangzhou Duling Technology Co., Ltd., Guangzhou (CN)

(72) Inventor: Fuzhi YANG, Guangzhou (CN)

(21) Appl. No.: 19/429,983

(22) Filed: Dec. 22, 2025

(30) Foreign Application Priority Data
Mar. 19, 2025 (CN) 202510330910.4

(51) Int. Cl. G06F 8/61

(52) U.S. Cl. CPC G06F 8/63

(57) ABSTRACT

A software installation method for a cloud phone, an electronic device and a storage medium are provided. The method includes: acquiring an address list of image files of software installation packages, where software identifiers and storage addresses are stored in association in the address list; in response to receiving a request for installing target software in a cloud phone, obtaining a target address by searching the address list according to the software identifier of the target software; downloading an image file of the target software from the target address, where the image file includes an application package and a resource package; and installing the target software based on the application package and the resource package.

### CROSS-REFERENCE TO RELATED APPLICATIONS

This application claims the priority from Chinese Patent Application No. 202510330910.4, filed with the China National Intellectual Property Administration (CNIPA) on March 19, 2025, the entire disclosure of which is hereby incorporated by reference.

### TECHNICAL FIELD

The present disclosure relates to the technical field of cloud computing, and in particular to the technical field of cloud phone, and in more particular to a software installation method for a cloud phone, an electronic device and a storage medium.

### BACKGROUND

Cloud phones are virtual phones running on cloud servers, widely used in mobile office, cloud gaming, and other fields. In related technologies, installing applications on cloud phones requires downloading resource files.

### SUMMARY

The present disclosure provides a software installation method and apparatus for a cloud phone, an electronic device and a storage medium.

According to a first aspect of the present disclosure, a software installation method for a cloud phone is provided, including: obtaining an address list of image files of software installation packages, where software identifiers and storage addresses are stored in association in the address list; in response to receiving a request for installing a target software in a cloud phone, obtaining a target address by searching the address list according to a software identifier of the target software; downloading an image file of the target software from the target address, where the image file includes an application package and a resource package; and installing the target software based on the application package and the resource package.

According to a second aspect of the present disclosure, an electronic device is provided, including: at least one processor; and a memory communicatively connected to the at least one processor; where the memory stores instructions executable by the at least one processor, and the instructions, when executed by the at least one processor, enable the at least one processor to perform the method according to any one of the first aspect.

According to a third aspect of the present disclosure, a non-transitory computer- readable storage medium storing computer instructions is provided, where the computer instructions, when executed by a processor, cause a computer to perform the method according to any one of the first aspect.

It should be understood that the description in this section is not intended to identify key or critical features of the embodiments of the disclosure, nor is it intended to limit the scope of the disclosure. Other features of the present disclosure will become readily apparent from the following description.

### BRIEF DESCRIPTION OF THE DRAWINGS

The drawings are used to better understand the solution and do not constitute a limitation to the present disclosure.

FIG. 1 is a schematic diagram of an exemplary system architecture to which embodiments of the present disclosure may be applied;

FIG. 2 is a flowchart of a software installation method for a cloud phone according to an embodiment of the present disclosure;

FIG. 3 is a schematic diagram of an application scenario of the software installation method for a cloud phone according to the present disclosure.

FIG. 4 is a flowchart of a software installation method for a cloud phone according to still another embodiment of the present disclosure;

FIG. 5 is a structural schematic diagram of the software installation apparatus for a cloud phone according to an embodiment of the present disclosure.

FIG. 6 is a structural schematic diagram of a computer system of an electronic device suitable for implementing embodiments of the present disclosure.

### DETAILED DESCRIPTION OF EMBODIMENTS

The following describes exemplary embodiments of the present disclosure with reference to the accompanying drawings, which include various details of the embodiments of the present disclosure to facilitate understanding, and they should be regarded as merely exemplary. Therefore, those of ordinary skill in the art should recognize that various changes and modifications may be made to the embodiments described herein without departing from the scope and spirit of the present disclosure. Similarly, descriptions of well-known functions and structures are omitted in the following for clarity and conciseness.

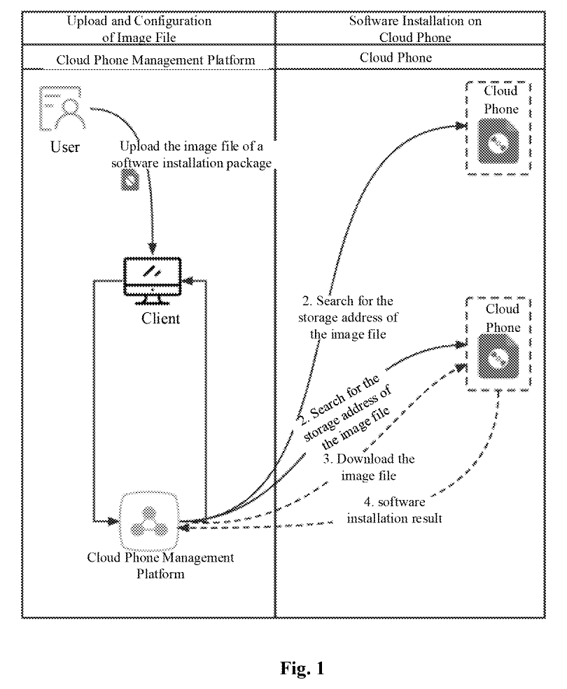

FIG. 1 shows an exemplary system architecture to which embodiments of the software installation method for a cloud phone or the software installation apparatus for a cloud phone of the present disclosure may be applied.

As shown in FIG. 1, the system architecture may include a cloud phone management platform and at least one cloud phone. A cloud phone corresponds to a virtual machine of a physical machine. The cloud phone management platform is communicatively connected to the physical machine through a wired network or a wireless network.

A user may use the cloud phone management platform to interact with the physical machine through a network, to receive or send messages and the like. A cloud phone management application may be installed on the cloud phone management platform.

The cloud phone management platform may be various intelligent or non- intelligent electronic devices with a display screen and a camera, including but not limited to a smart phone, a tablet computer, an e-book reader, an MP3 player (Moving Picture Experts Group Audio Layer III), an MP4 player (Moving Picture Experts Group Audio Layer IV), a laptop computer, a desktop computer and the like. When the cloud phone management platform is software, it may be installed in the above-listed electronic devices. It may be implemented as multiple software pieces or software modules (for example, to provide distributed services), or as a single software piece or software module, which is not specifically limited herein.

The physical machine may be a server that provides various services, for example, a background cloud phone server that provides support for the cloud phone interface displayed on the cloud phone management platform. The background cloud phone server can receive a management request (such as installing an application program) for a target cloud phone, forward the management request to the virtual machine corresponding to the target cloud phone, and then perform cloud phone management.

The physical machine may be implemented as a distributed server cluster composed of multiple servers, or as a single server, which is not specifically limited herein. The physical machine may also be a server of a distributed system, or a server combined with a blockchain. The physical machine may also be a cloud server, or an intelligent cloud computing server or an intelligent cloud host with artificial intelligence technology.

The cloud phone management platform and the cloud phone may communicate directly, or they may communicate through message forwarding via other servers.

The software installation process based on the cloud phone is as shown in FIG. 1.

1. A software developer pre-makes a software installation package into an image file, and then uploads it to the cloud phone management platform through a client. The software installation package in the present disclosure includes not only an application package but also a resource package, which is different from an ordinary installation package.

2. A cloud phone user initiates a software installation request for installing software on at least one cloud phone (installing software on two cloud phones, as an example in the figure) to the cloud phone management platform, and the cloud phone obtains the storage address of the image file from the cloud phone management platform.

3. The cloud phone downloads the image file according to the storage address.

4. The cloud phone performs software installation and returns the software installation result to the cloud phone management platform.

It should be noted that the software installation method for a cloud phone provided by embodiments of the present disclosure may be executed by the cloud phone management platform or the physical machine. Correspondingly, the software installation apparatus for a cloud phone may be disposed in the cloud phone management platform or the physical machine, which is not specifically limited herein.

It should be understood that the numbers of cloud phone management platforms and cloud phones in FIG. 1 are merely schematic. According to implementation requirements, there may be any number of cloud phone management platforms and cloud phones.

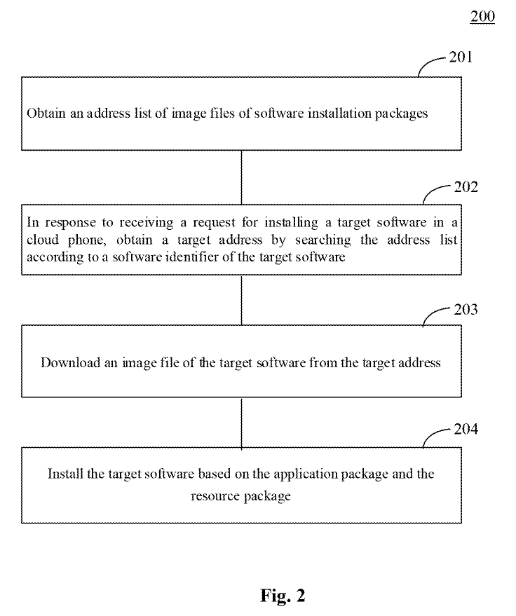

With further reference to FIG. 2, a flowchart 200 of a software installation method for a cloud phone according to an embodiment of the present disclosure is shown. The software installation method for a cloud phone includes the following steps.

Step 201 includes: obtaining an address list of image files of software installation packages.

In this embodiment, an execution subject (for example, the physical machine where the cloud phone is located as shown in FIG. 1) of the software installation method for a cloud phone may obtain the address list of image files of software installation packages from the cloud phone management platform through a wired connection mode or a wireless connection mode. Here, software identifiers and storage addresses are stored in association in the address list.

When releasing an application package, software developers may package the resource packages required for application installation together to generate an image file of the software installation package. The image file is stored in a distributed union file system managed by the cloud phone management platform. The software identifier and storage address of the image file of each software installation package are recorded in an address list maintained by the cloud phone management platform.

Step 202 includes: in response to receiving a request for installing a target software in a cloud phone, obtaining a target address by searching the address list according to a software identifier of the target software.

In this embodiment, a request for installing a target software in a cloud phone may be initiated on the cloud phone management platform or the cloud phone. The installation request may be initiated through a command line, for example, a predetermined command + a software installation package name + an image file name.

Optionally, the request for installing a target software may also be initiated by selecting the target software to be installed through a visual interface provided by a pre- developed software installation tool.

The storage address of the target software may be obtained as the target address by searching the address list according to the software identifier of the target software.

Optionally, one image file may be stored at multiple different addresses. A suitable address may be selected for the downloading according to user requirements, for example, selecting the nearest address or the address with the fastest network speed and the like.

Step 203 includes: downloading an image file of the target software from the target address.

In this embodiment, the image file of the target software is downloaded from the target address to the physical machine where the cloud phone is located. Here, the image file includes an application package and a resource package.

Step 204 includes: installing the target software based on the application package and the resource package.

In this embodiment, the target software may be installed by means of image file restoration, resource data is obtained from the resource package during the installation of the application package without additionally downloading resources, which saves installation time.

The method provided by the above embodiments of the present disclosure eliminates the need for customers to additionally download resource packages during the software installation process, thereby reducing traffic bandwidth costs and improving software installation speed. The method may be applied to large-scale game scenarios and is suitable for cloud phones from various manufacturers.

In some optional implementations of this embodiment, the image file is backup- stored in multiple nodes of a content delivery network of a distributed union file system, and one software identifier in the address list corresponds to multiple storage addresses; and obtaining a target address by searching the address list based on the software identifier of the target software includes: searching the address list for an address of a node in the content delivery network closest to the physical device where the cloud phone is located based on the software identifier of the target software, and using the address as the target address.

The Distributed Union File System (DUES) is a feature-rich file server supporting multiple file management and access methods, applicable to various application scenarios.

The basic concept of the Content Delivery Network (CDN) is to avoid bottlenecks and links on the Internet that may affect data transmission speed and stability as much as possible, enabling content to be transmitted faster and more stably. By placing node servers throughout the network to form an intelligent virtual network on top of the existing Internet infrastructure, the CDN system can redirect user requests to service nodes closest to users in real time based on comprehensive information such as network traffic, connection and load status of each node, distance to users, and response time. Its purpose is to enable users to obtain required content nearby, alleviate Internet network congestion, and improve user access response speed.

The image file is stored with identical backups in multiple nodes of the CDN, from which the address of the node closest to the physical device where the cloud phone is located may be selected as the target address. This can reduce data transmission latency and improve download speed.

In some optional implementation manners of this embodiment, the image file is backup-stored in multiple nodes of a content delivery network of a distributed union file system, and one software identifier in the address list corresponds to multiple storage addresses; and obtaining a target address by searching the address list based on the software identifier of the target software includes: searching the address list for an address of a node in the content delivery network belonging to the same local area network as the physical device where the cloud phone is located based on the software identifier of the target software, and using the address as the target address.

The image file is stored with identical backups in multiple nodes of the CDN, from which the address of the node belonging to the same local area network as the physical device where the cloud phone is located may be selected as the target address. Data transmission within a local area network is free and fast, which can reduce traffic bandwidth costs and improve data security without connecting to the external network.

In some optional implementations of this embodiment, the method further includes: in response to detecting that a resource file required by the target software has changed, generating a changed resource package based on the changed resource file; generating an updated target image file based on the changed resource package and the application package; and uploading the updated target image file to the target address.

If a resource file is added or deleted during the use of the target software, that is, the resource file changes, a changed resource package is generated based on the changed resource file. Then an updated target image file is generated based on the changed resource package and the application package. The updated target image file is then uploaded to the target address. This target address is the node closest to the current cloud phone or a node in the same local area network as described above. After detecting the update of the target image file, the cloud phone management platform may synchronize the updated target image file to other nodes of the CDN, facilitating download and use by other cloud phones. Thereby the image file can be updated at any time to repair software vulnerabilities in a timely manner, and network resources and update time can be saved during the update.

In some optional implementations of this embodiment, the request indicates batch installation of the target software in multiple cloud phones; and obtaining a target address by searching the address list based on the software identifier of the target software includes: searching the address list for addresses of nodes in the content delivery network closest to the physical devices where the multiple cloud phones are located respectively based on the software identifier of the target software, and using the addresses as target addresses for the respective cloud phones; or searching the address list for addresses of nodes in the content delivery network belonging to the same local area network as the physical devices where the multiple cloud phones are located respectively based on the software identifier of the target software, and using the addresses as target addresses for the respective cloud phones; and downloading the target image file from the target address includes: downloading the target image file from the target addresses for the respective cloud phones to the physical devices where the respective cloud phones are located.

The target software may be batch-installed on different cloud phones, and each cloud phone may download the image file from the node closest to itself or from a node in the same local area network. This can save network resources for each cloud phone and improve installation speed, thereby improving the overall installation efficiency and cost of the system.

In some optional implementations of this embodiment, acquiring the address list of image files of software installation packages includes: installing a software installation tool; in response to detecting that the software installation tool is started, acquiring the address list of image files from a Software as a Service platform; and displaying installation options including software identifiers in the address list in a visual interface.

The address list of image files of software installation packages may be acquired from the cloud phone management platform through a self-developed software installation tool. The cloud phone management platform may be a Software as a Service (SaaS) platform. After installation, the software installation tool connects to the cloud phone management platform and acquires the address list maintained by the cloud phone management platform, but does not display the address list in the visual interface, only displaying installation options including software identifiers in the address list. Users do not need to know what the addresses are; they only need to select the target software to be installed according to the software identifier, and the software installation tool can obtain the target address by searching in the background based on the software identifier of the target software, and then download the image file from the target address. The visual interface facilitates users to install target software with simple operations that do not require professional personnel, thereby lowering the usage threshold.

In some optional implementations of this embodiment, in response to receiving a request for installing target software in a cloud phone, obtaining a target address by searching the address list based on the software identifier of the target software includes: in response to detecting that an installation option is selected, obtaining the target address by searching the address list based on the software identifier of the selected installation option.

Users can select the target software to be downloaded in the visual interface without learning how to use the command line, with simple operations that do not require professional personnel, thereby lowering the usage threshold.

In some optional implementations of this embodiment, in response to receiving a request for installing target software in a cloud phone, obtaining a target address by searching the address list based on the software identifier of the target software includes: in response to receiving a predetermined software installation command line, obtaining the software identifier of the target software by parsing the software installation command line; and obtaining the target address by searching the address list based on the software identifier of the target software.

Installation may also be performed using a command line instead of a visual interface. Command line installation is more efficient, reduces latency, and requires fewer computing resources. Passing parameters to the installation program through the command line can provide finer-grained option settings, allowing users to customize the installation process completely according to their needs.

In some optional implementations of this embodiment, the address list further includes software version numbers; and the method further includes: in response to detecting that the software version number of the target software in the address list is updated, downloading the updated target image file from the target address; and updating the target software based on the application package and resource package of the updated target image file.

The address list may be periodically acquired from the cloud phone management platform to detect whether the software version number of the target software in the address list is updated. If updated, the updated image file is automatically downloaded and automatically installed. Through automatic updates, known security vulnerabilities can be patched to prevent malicious attackers from exploiting these vulnerabilities to damage systems or data. Existing functions can be improved, new features can be added, and bugs existing in previous versions can be fixed. Users can enjoy better user experience and more stable application performance without manual checking. Compatibility of software versions is ensured to avoid problems caused by version mismatch.

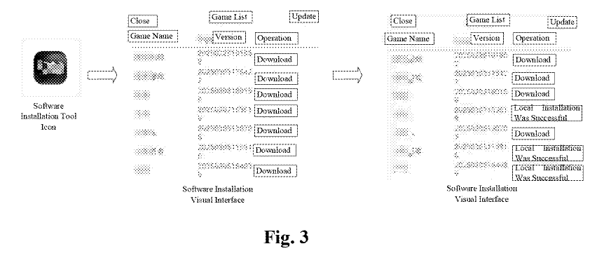

With further reference to FIG. 3, FIG. 3 is a schematic diagram of an application scenario of the software installation method for a cloud phone according to this embodiment. In the application scenario of FIG. 3, downloading a game software is taken as an example. A software installation tool may be pre-installed on the cloud phone. The software installation tool may be started by double-clicking the icon of the software installation tool. After the software installation tool is started, the user may select the type of software as a game, and then the software installation tool obtains a download list of game software from the cloud phone management platform. The user can select the game to be downloaded according to the game name and version. The user only needs to simply click the "Download" option. The software installation tool can query the storage address of the image file of the selected software in the background, download the image file from the storage address, and automatically install the software after the download is completed, and update the status in the game list.

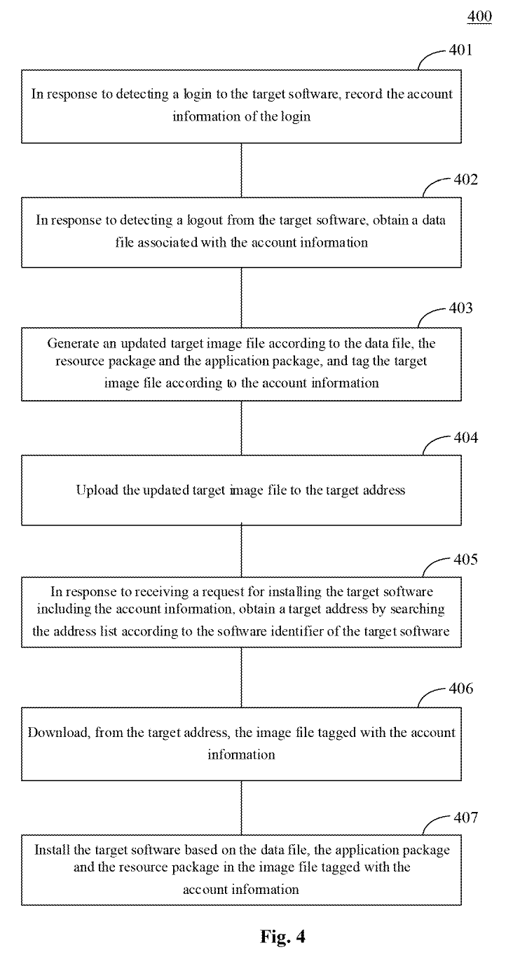

With further reference to FIG. 4, a flowchart 400 of yet another embodiment of a software installation method for a cloud phone is shown. The flowchart 400 of the software installation method for a cloud phone includes the following steps.

Step 401 includes: in response to detecting a login to the target software, recording the account information of the login.

In this embodiment, after the target software is installed on the cloud phone, the logged-in account information can be recorded by logging into the target software through an account.

Step 402 includes: in response to detecting a logout from the target software, obtaining a data file associated with the account information.

In this embodiment, if the user logs out of the target software, the data file used during the login period may be backed up. For example, if a new skin is purchased, resource data related to the new skin needs to be downloaded. These data are associated with the user account, even if the user logs in from a different device, the data file previously used by the user account can still be retrieved.

Step 403 includes: generating an updated target image file according to the data file, the resource package and the application package, and tagging the target image file according to the account information.

In this embodiment, the data file associated with the account information, and the resource package and application package originally obtained during software installation are used to generate an updated target image file. This file is user-specific, so it can be tagged with the account information.

Step 404 includes: uploading the updated target image file to the target address.

In this embodiment, the updated target image file is uploaded to the target address. The target address is the node closest to the current cloud phone or the node in the same local area network as the current cloud phone, as described above. The cloud phone management platform may synchronize the updated target image file to other nodes of the CDN after detecting the update of the target image file, so as to facilitate downloading and use by other cloud phones. Thus, the image file may be updated at any time, software vulnerabilities can be repaired in a timely manner, and network resources and update time are saved during the update.

Step 405 includes: in response to receiving a request for installing the target software including the account information, obtaining a target address by searching the address list according to the software identifier of the target software.

In this embodiment, account information may be specified during software installation, so that the cloud phone management platform may be searched for the storage address of the image file tagged with the account information.

Step 406 includes: downloading, from the target address, the image file tagged with the account information.

In this embodiment, image files tagged with account information uploaded by different users can be stored in separate folders on the same node, and the account information is used to search for the corresponding image file and the corresponding image file is downloaded.

Step 407 includes: installing the target software based on the data file, the application package and the resource package in the image file tagged with the account information.

In this embodiment, the target software may be installed by means of image file restoration, the data from the previous login is directly obtained from the data file during the installation of the application package, and resource data is obtained from the resource package, without additionally downloading resources and updating user data, and the status of the previous login is directly restored, which saves installation time.

The method provided by the above embodiment of the present disclosure can still maintain the status of the previous login when switching cloud phone devices, without spending extra time updating the account state.

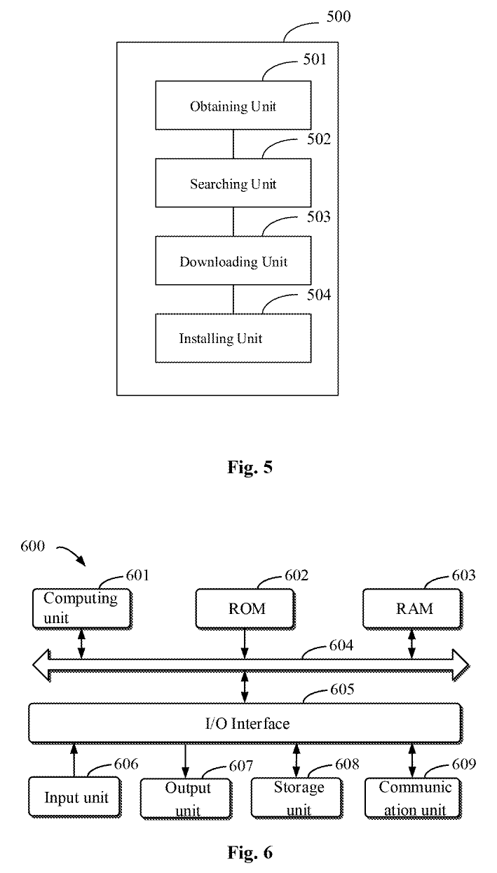

With further reference to FIG. 5, as an implementation of the methods shown in the above figures, an embodiment of the present disclosure provides a software installation apparatus for a cloud phone, which corresponds to the method embodiment shown in FIG. 2, and the apparatus can be specifically applied to various electronic devices.

As shown in FIG. 5, the software installation apparatus 500 for a cloud phone of this embodiment includes: an obtaining unit 501, a searching unit 502, a downloading unit 503 and an installing unit 504. The obtaining unit 501 is configured to obtain an address list of image files of software installation packages, where software identifiers and storage addresses are stored in association in the address list; the searching unit 502 is configured to, in response to receiving a request for installing a target software in a cloud phone, obtain a target address by searching the address list according to a software identifier of the target software; the downloading unit 503 is configured to download an image file of the target software from the target address, where the image file includes an application package and a resource package; and the installing unit 504 is configured to install the target software based on the application package and the resource package.

In this embodiment, the specific processing of the obtaining unit 501, the searching unit 502, the downloading unit 503 and the installing unit 504 of the software installation apparatus 500 for a cloud phone can refer to Step 201, Step 202, Step 203 and Step 204 in the embodiment corresponding to FIG. 2.

In some optional implementations of this embodiment, the image file is stored in backup in multiple nodes of a content delivery network of a distributed union file system, and in the address list one software identifier corresponds to multiple storage addresses; and the searching unit 502 is further configured to: search, according to the software identifier of the target software, the address list for an address of a node that is closest to the physical device where the cloud phone is located in the content delivery network as the target address.

In some optional implementations of this embodiment, the image file is stored in backup in multiple nodes of a content delivery network of a distributed union file system, and in the address list one software identifier corresponds to multiple storage addresses; and the searching unit 502 is configured to: search, according to the software identifier of the target software, the address list for an address of a node that belongs to one same local area network as a physical device where the cloud phone is located in the content delivery network as the target address.

In some optional implementations of this embodiment, the apparatus 500 further includes an updating unit configured to: in response to detecting that a resource file required by the target software is changed, generate a changed resource package according to the changed resource file; generate an updated target image file according to the changed resource package and the application package; and upload the updated target image file to the target address.

In some optional implementations of this embodiment, the apparatus 500 further includes a customizing unit configured to: in response to detecting a login to the target software, record the account information of the login; in response to detecting a logout from the target software, obtain a data file associated with the account information; generate an updated target image file according to the data file, the resource package and the application package, and tag the target image file according to the account information; and upload the updated target image file to the target address.

In some optional implementations of this embodiment, the customizing unit is further configured to: in response to receiving a request for installing the target software including the account information, obtain a target address by searching the address list according to the software identifier of the target software; download, from the target address, an image file tagged with the account information; and install the target software based on the data file, the application package and the resource package in the image file tagged with the account information.

In some optional implementations of this embodiment, the request is used to instruct to install the target software in batches on multiple cloud phones; and the searching unit 502 is further configured to: search, according to the software identifier of the target software, the address list for addresses of nodes that are respectively closest to the physical devices where the multiple cloud phones are located as the target addresses of the cloud phones; or search, according to the software identifier of the target software, the address list for addresses of nodes in the content delivery network that respectively belong to the same local area networks as the physical devices where the multiple cloud phones are located as the target addresses of the cloud phones; and the step of downloading the target image file from the target address includes: downloading target image files from the target addresses of the cloud phones to the physical devices where cloud phones are located.

In some optional implementations of this embodiment, the obtaining unit 501 is further configured to: install a software installation tool; in response to detecting startup of the software installation tool, obtain the address list of the image files from a Software as a Service platform; and display, in a visual interface, installation options including the software identifiers in the address list.

In some optional implementations of this embodiment, the searching unit 502 is further configured to: in response to detecting that an installation option is selected, obtain a target address by searching the address list according to a software identifier of the selected installation option.

In some optional implementations of this embodiment, the searching unit 502 is further configured to: in response to receiving a predetermined software installation command line, obtain the software identifier of the target software by parsing the software installation command line; and search for the target address from the address list according to the software identifier of the target software.

In some optional implementations of this embodiment, the address list further includes a software version number; and the apparatus is configured to: in response to detecting that the software version number of the target software in the address list is updated, download an updated target image file from the target address; and update the target software based on the application package and the resource package of the updated target image file.

In the technical solution of the present disclosure, the collection, storage, use, processing, transmission, provision and disclosure of user personal information all comply with the relevant laws and regulations and do not violate public order and good morals.

According to embodiments of the present disclosure, the present disclosure also provides an electronic device, a readable storage medium and a computer program product.

An electronic device includes: at least one processor; and a memory communicatively connected to the at least one processor; where the memory stores instructions executable by the at least one processor, and the instructions, when executed by the at least one processor, enable the at least one processor to perform the method in the process 200.

A non-transitory computer-readable storage medium storing computer instructions, where the computer instructions, when executed by a processor, cause the computer to perform the method in the process 200.

A computer program product includes a computer program, which, when executed by a processor, implements the method in the process 200.

FIG. 6 shows a schematic block diagram of an example electronic device 600 that may be used to implement the embodiments of the present disclosure. The electronic device is intended to represent various forms of digital computers, such as laptop computers, desktop computers, workstations, personal digital assistants, servers, blade servers, mainframe computers, and other suitable computers. The electronic device may also represent various forms of mobile devices, such as personal digital processors, cellular phones, smart phones, wearable devices, and other similar computing devices. The components shown herein, their connections and relationships, and their functions are merely examples, and are not intended to limit the implementation of the present disclosure described and/or claimed herein.

As shown in FIG. 6, the device 600 includes a computing unit 601, which can perform various appropriate actions and processes according to a computer program stored in a Read-Only Memory (ROM) 602 or a computer program loaded into a Random-Access Memory (RAM) 603 from a storage unit 608. Various programs and data required for the operation of the device 600 may also be stored in the RAM 603. The computing unit 601, the ROM 602 and the RAM 603 are connected to each other through a bus 604. An Input/Output (I/O) interface 605 is also connected to the bus 604.

A number of components in the device 600 are connected to the I/O interface 605, including: an input unit 606 such as a keyboard, a mouse, etc.; an output unit 607 such as various types of displays, speakers, etc.; a storage unit 608 such as a magnetic disk, an optical disk, etc.; and a communication unit 609 such as a network card, a modem, a wireless communication transceiver, etc. The communication unit 609 allows the device 600 to exchange information/data with other devices through a computer network such as the Internet and/or various telecommunication networks.

The computing unit 601 may be various general-purpose and/or special-purpose processing components with processing and computing capabilities. Some examples of the computing unit 601 include, but are not limited to, a Central Processing Unit (CPU), a Graphics Processing Unit (GPU), various dedicated Artificial Intelligence (AI) computing chips, various computing units running machine learning model algorithms, a Digital Signal Processor (DSP), and any suitable processor, controller, microcontroller, etc. The computing unit 601 executes the various methods and processes described above, such as the software installation method for a cloud phone. For example, in some embodiments, the software installation method for a cloud phone may be implemented as a computer software program tangibly embodied in a machine-readable medium, such as the storage unit 608. In some embodiments, part or all of the computer program may be loaded and/or installed onto the device 600 via the ROM 602 and/or the communication unit 609. When the computer program is loaded into the RAM 603 and executed by the computing unit 601, one or more steps of the software installation method for a cloud phone described above may be performed. Alternatively, in other embodiments, the computing unit 601 may be configured to perform the software installation method for a cloud phone by any other suitable means (e.g., by means of firmware).

Various implementations of the systems and technologies described herein may be implemented in digital electronic circuit systems, integrated circuit systems, Field- Programmable Gate Arrays (FPGAs), Application-Specific Integrated Circuits (ASICs), Application-Specific Standard Products (ASSPs), System on Chip (SOC), Complex Programmable Logic Devices (CPLDs), computer hardware, firmware, software, and/or combinations thereof. These various implementations may include: being implemented in one or more computer programs that can be executed and/or interpreted on a programmable system including at least one programmable processor, which may be a special-purpose or general-purpose programmable processor that can receive data and instructions from a storage system, at least one input device, and at least one output device, and transmit data and instructions to the storage system, the at least one input device, and the at least one output device.

Program code for implementing the method of the present disclosure may be written in any combination of one or more programming languages. These program codes may be provided to a processor or controller of a general-purpose computer, a special- purpose computer, or other programmable data processing apparatus, so that the program codes, when executed by the processor or controller, cause the functions/operations specified in the flowcharts and/or block diagrams to be implemented. The program codes may be executed entirely on the machine, partly on the machine, as a stand-alone software package partly on the machine and partly on a remote machine, or entirely on the remote machine or server.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine- readable medium may include, but is not limited to, an electronic, magnetic, optical, electromagnetic, infrared, or semiconductor system, apparatus, or device, or any suitable combination of the above. A more specific example of the machine-readable storage medium will include an electrical connection based on one or more wires, a portable computer diskette, a hard disk, a Random-Access Memory (RAM), a Read-Only Memory (ROM), an Erasable Programmable Read-Only Memory (EPROM or flash memory), an optical fiber, a portable Compact Disc Read-Only Memory (CD-ROM), an optical storage device, a magnetic storage device, or any suitable combination of the above.

To provide interaction with a user, the systems and technologies described herein may be implemented on a computer having: a display device (e.g., a Cathode Ray Tube (CRT) or a Liquid Crystal Display (LCD) monitor) for displaying information to the user; and a keyboard and a pointing device (e.g., a mouse or a trackball) through which the user can provide input to the computer. Other types of devices may also be used to provide interaction with the user; for example, the feedback provided to the user may be any form of sensory feedback (e.g., visual feedback, auditory feedback, or tactile feedback); and input from the user may be received in any form (including acoustic input, speech input, or tactile input).

The systems and technologies described herein may be implemented in a computing system including a back-end component (e.g., as a data server), or a middleware component (e.g., an application server), or a front-end component (e.g., a user computer with a graphical user interface or a web browser through which the user can interact with an implementation of the systems and technologies described herein), or any combination of such back-end components, middleware components, or front-end components. The components of the system may be interconnected by any form or medium of digital data communication (e.g., a communication network). Examples of communication networks include: a Local Area Network (LAN), a Wide Area Network (WAN), and the Internet.

The computer system may include a client and a server. The client and server are generally remote from each other and typically interact through a communication network. The relationship of client and server arises by virtue of computer programs running on the respective computers and having a client-server relationship to each other. The server may be a cloud server, or a server of a distributed system, or a server incorporating a blockchain.

It should be understood that the various forms of processes shown above may be used to reorder, add, or delete steps. For example, the steps recorded in the present disclosure may be executed in parallel, sequentially, or in a different order, as long as the desired result of the technical solution disclosed in the present disclosure can be achieved, and no limitation is made herein.

The above detailed description does not constitute a limitation to the scope of the present disclosure. It should be apparent to those skilled in the art that various modifications, combinations, sub-combinations and substitutions may be made according to design requirements and other factors. Any modifications, equivalent substitutions and improvements made within the spirit and principle of the present disclosure shall be included in the scope of the present disclosure.

What is claimed is:

1. A software installation method for a cloud phone, comprising:obtaining an address list of image files of software installation packages, wherein software identifiers and storage addresses are stored in association in the address list;in response to receiving a request for installing a target software in a cloud phone,
obtaining a target address by searching the address list according to a software identifier of the target software;downloading an image file of the target software from the target address, wherein the image file includes an application package and a resource package; andinstalling the target software based on the application package and the resource package.

2. The method according to claim 1, wherein the image file is stored in backup in a plurality of nodes of a content delivery network of a distributed union file system, and in the address list, one software identifier corresponds to a plurality of storage addresses; andthe obtaining the target address by searching the address list according to the software identifier of the target software comprises:searching, according to the software identifier of the target software, the address list
for an address of a node that is closest to a physical device where the cloud phone is located in the content delivery network as the target address.

3. The method according to claim 1, wherein the image file is stored in backup in a plurality of nodes of a content delivery network of a distributed union file system, and in the address list, one software identifier corresponds to a plurality of storage addresses; andthe obtaining the target address by searching the address list according to a software identifier of the target software comprises:
searching, according to the software identifier of the target software, the address list for an address of a node that belongs to one same local area network as a physical device where the cloud phone is located in the content delivery network as the target address.

4. The method according to claim 1, further comprising:in response to detecting that a resource file required by the target software is changed, generating a changed resource package according to the changed resource file;generating an updated target image file according to the changed resource package and the application package; anduploading the updated target image file to the target address.

5. The method according to claim 1, further comprising:in response to detecting a login to the target software, recording account information of the login;in response to detecting a logout from the target software, obtaining a data file associated with the account information;generating an updated target image file according to the data file, the resource package and the application package, and tagging the target image file according to the account information; anduploading the updated target image file to the target address.

6. The method according to claim 5, further comprising:in response to receiving a request for installing the target software including the account information, searching the address list for a target address according to the
software identifier of the target software;downloading, from the target address, the image file tagged with the account information; andinstalling the target software based on the data file, the application package and the resource package in the image file tagged with the account information.

7. The method according to claim 1, wherein the request instructs to install the target software in batches on a plurality of cloud phones; andthe obtaining the target address by searching the address list according to the
software identifier of the target software comprises:searching, according to the software identifier of the target software, the address list for addresses of nodes that are respectively closest to physical devices where the plurality of cloud phones are located in the content delivery network as the target addresses for the cloud phones; or searching, according to the software identifier of the target software, the address list for addresses of nodes that respectively belong to same local area networks as the physical devices where the plurality of cloud phones are located in the content delivery network as the target addresses for the cloud phones; andthe downloading the target image file from the target address comprises:downloading target image files from the target addresses of the cloud phones to the physical devices where the cloud phones are located.

8. The method according to claim 1, wherein the obtaining an address list of image files of software installation packages comprises:installing a software installation tool;in response to detecting startup of the software installation tool, obtaining the address list of the image files from a Software as a Service platform; anddisplaying, in a visual interface, installation options including the software identifiers in the address list.

9. The method according to claim 8, wherein in response to receiving the request for installing the target software in the cloud phone, the obtaining the target address by searching the address list according to the software identifier of the target software comprises:
in response to detecting that an installation option is selected, obtaining the target address by searching the address list according to a software identifier of the selected installation option.

10. The method according to claim 1, wherein in response to receiving the request for installing the target software in the cloud phone, obtaining the target address by searching the address list according to the software identifier of the target software comprises:in response to receiving a predetermined software installation command line, obtaining the software identifier of the target software by parsing the software installation command line; andobtaining the target address by searching the address list according to the software identifier of the target software.

11. The method according to claim 1, wherein the address list further includes a software version number; andthe method further comprises:in response to detecting that a software version number of the target software in the address list is updated, downloading an updated target image file from the target address;
and updating the target software based on the application package and the resource package of the updated target image file.

12. An electronic device, comprising:at least one processor; anda memory communicatively connected to the at least one processor; wherein the memory stores instructions executable by the at least one processor, and the instructions, when executed by the at least one processor, enable the at least one processor to perform operations comprising:
obtaining an address list of image files of software installation packages, wherein software identifiers and storage addresses are stored in association in the address list;in response to receiving a request for installing a target software in a cloud phone,
obtaining a target address by searching the address list according to a software identifier
of the target software;downloading an image file of the target software from the target address, wherein the image file includes an application package and a resource package; andinstalling the target software based on the application package and the resource package.

13. The electronic device according to claim 12, wherein the image file is stored in backup in a plurality of nodes of a content delivery network of a distributed union file system, and in the address list, one software identifier corresponds to a plurality of storage addresses; andthe obtaining the target address by searching the address list according to the software identifier of the target software comprises:searching, according to the software identifier of the target software, the address list for an address of a node that is closest to a physical device where the cloud phone is located in the content delivery network as the target address.

14. The electronic device according to claim 12, wherein the image file is stored in backup in a plurality of nodes of a content delivery network of a distributed union file system, and in the address list, one software identifier corresponds to a plurality of storage addresses; andthe obtaining the target address by searching the address list according to a software identifier of the target software comprises:searching, according to the software identifier of the target software, the address list for an address of a node that belongs to one same local area network as a physical device where the cloud phone is located in the content delivery network as the target address.

15. The electronic device according to claim 12, wherein the operations further comprise:in response to detecting that a resource file required by the target software is changed, generating a changed resource package according to the changed resource file;generating an updated target image file according to the changed resource package and the application package; anduploading the updated target image file to the target address.

16. The electronic device according to claim 12, wherein the operations further comprise:in response to detecting a login to the target software, recording account information of the login;in response to detecting a logout from the target software, obtaining a data file associated with the account information;generating an updated target image file according to the data file, the resource
package and the application package, and tagging the target image file according to the account information; anduploading the updated target image file to the target address.

17. The electronic device according to claim 16, wherein the operations further comprise:in response to receiving a request for installing the target software including the account information, searching the address list for a target address according to the software identifier of the target software;downloading, from the target address, the image file tagged with the account information; andinstalling the target software based on the data file, the application package and the resource package in the image file tagged with the account information.

18. The electronic device according to claim 12, wherein the request instructs to install the target software in batches on a plurality of cloud phones; and 25
the obtaining the target address by searching the address list according to the software identifier of the target software comprises:searching, according to the software identifier of the target software, the address list for addresses of nodes that are respectively closest to physical devices where the
plurality of cloud phones are located in the content delivery network as the target addresses for the cloud phones; or searching, according to the software identifier of the target software, the address list for addresses of nodes that respectively belong to same local area networks as the physical devices where the plurality of cloud phones are located in the content delivery network as the target addresses for the cloud phones; andthe downloading the target image file from the target address comprises:downloading target image files from the target addresses of the cloud phones to the physical devices where the cloud phones are located.

19. The electronic device according to claim 12, wherein the obtaining an address list of image files of software installation packages comprises:installing a software installation tool;in response to detecting startup of the software installation tool, obtaining the address list of the image files from a Software as a Service platform; anddisplaying, in a visual interface, installation options including the software identifiers in the address list.

20. A non-transitory computer-readable storage medium storing computer instructions,wherein the computer instructions, when executed by a processor, cause a computer to perform the operations comprising:obtaining an address list of image files of software installation packages, wherein software identifiers and storage addresses are stored in association in the address list;
in response to receiving a request for installing a target software in a cloud phone,
obtaining a target address by searching the address list according to a software identifier of the target software;downloading an image file of the target software from the target address, wherein
the image file includes an application package and a resource package; andinstalling the target software based on the application package and the resource package.
